(19) United States
(12) Patent Application Publication
(10) Pub. No.: US 2006/0130995 A1
(43) Pub. Date: Jun. 22, 2006

(54) System and process for forming glass-coated microwires, including a cooling system and process

(75) Inventors: Eliezer Adar, Sde Varburg (IL); Ehud Yaffe, Kibutz Yifat (IL)

Correspondence Address: OBLON, SPIVAK, MCCLELLAND, MAIER & NEUSTADT, P.C., 1940 DUKE STREET, ALEXANDRIA, VA, 22314, US

(73) Assignee: G.M.W.T. (GLOBAL MICRO WIRE TECHNOLOGY) LTD., Even Yehuda (IL)

(21) Appl. No.: 11/014,870

(22) Filed: Dec. 20, 2004

(51) Int. Cl. C03B 13/10; B22D 11/00; B22D 11/124

(52) U.S. Cl. 164/461; 65/146; 164/462; 164/486

(57) ABSTRACT

A system for generating glass-coating microwires that can particularly apply a uniform cooling to a glass tube filled with molten metal inserted into a tank including a cooling liquid. The uniform cooling allows the formation of a glass-coated microwire with a non-distorted and uniform glass coating.

### BACKGROUND OF THE INVENTION

1. Field of the Invention

The present invention is directed to a system and process for forming glass-coated microwires, and also to a cooling system utilized in a process and system for forming glass-coated microwires.

2. Discussion of the Background

Systems are known for forming glass-coated microwires, for example utilizing the Taylor-Ulitovsky process. U.S. Pat. No. 3,256,584, U.S. Pat. No. 5,240,066, and U.S. Pat. No. 6,270,591 all disclose processes for forming glass-coated microwires. In such processes after a structure of a glass tube filled with molten metal is extruded from a device, the glass tube with the molten metal is cooled.

U.S. Pat. No. 5,240,066 discloses a specific structure for providing such a cooling. In U.S. Pat. No. 5,240,066 a metal filled glass capillary is provided into a stream of a cooling liquid. The stream of cooling liquid supercools and solidifies the metal filled glass capillary to form a microwire, which is then received on a spool. In that device a rapid cooling is required to obtain the proper amorphous and microstructures in the glass-coated microwires.

### SUMMARY OF THE INVENTION

The present inventors have recognized that previously employed systems for cooling a glass tube filled with a molten metal in a process for forming glass-coated microwire suffer from drawbacks. Specifically, the cooling system disclosed in U.S. Pat. No. 5,240,066, which causes the glass tube filled with molten metal to enter a stream of a cooling liquid to be supercooled and solidified, suffers from a drawback in that the resulting glass-coated microwire may not have the proper uniformity and equilibrium of the glass coating, and further the glass coating diameter may be distorted.

More specifically, when a glass tube filled with molten metal is applied to a stream of a cooling liquid or gas, the side of the glass tube filled with molten metal closer to the output point of the cooling stream will contact the cooling stream first, and thus will begin to be cooled before the other side of the glass tube filled with molten metal. Because of the very small dimensions involved with glass-coated microwires, even such a small difference in the onset of cooling can result in undesirable variations or distortions in the uniformity and diameter of the glass coating in such produced glass-coated microwires.

Further, the present inventors recognized that every liquid stream is by its nature unstable and turbulent. Such inherent instability and turbulence in a liquid stream also results in the overall diameter of the microwire being non-uniform and/or distorted, in a system such as disclosed in U.S. Pat. No. 5,240,066.

Accordingly, one object of the present invention is to provide a novel system and process for forming a glass-coated microwire, and to provide a novel cooling system and process for a system and process for forming glass-coated microwire that can minimize or overcome the above-drawbacks in the background art.

A more specific object of the present invention is to provide a novel system and process for forming a glass-coated microwire, and novel cooling system and process for a system and process for forming glass-coated microwire in which a glass-coating with reduced uniformity and distortion can be realized.

The above-noted objects are achieved in the novel cooling system and method of the present invention by utilizing a stable and non-turbulent cooling operation, and more specifically by utilizing a tank filled with a liquid to receive the glass tube filled with molten metal.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1(a) and 1(b) show an overall system for generating glass-coated microwire according to the present invention;

FIG. 2 shows in isolation the cooling system for generating glass-coated microwire in a first state; and

FIG. 3 shows in isolation the cooling system for generating glass-coated microwire in a second state.

### DETAILED DESCRIPTION OF THE PREFERRED EMBODIMENTS

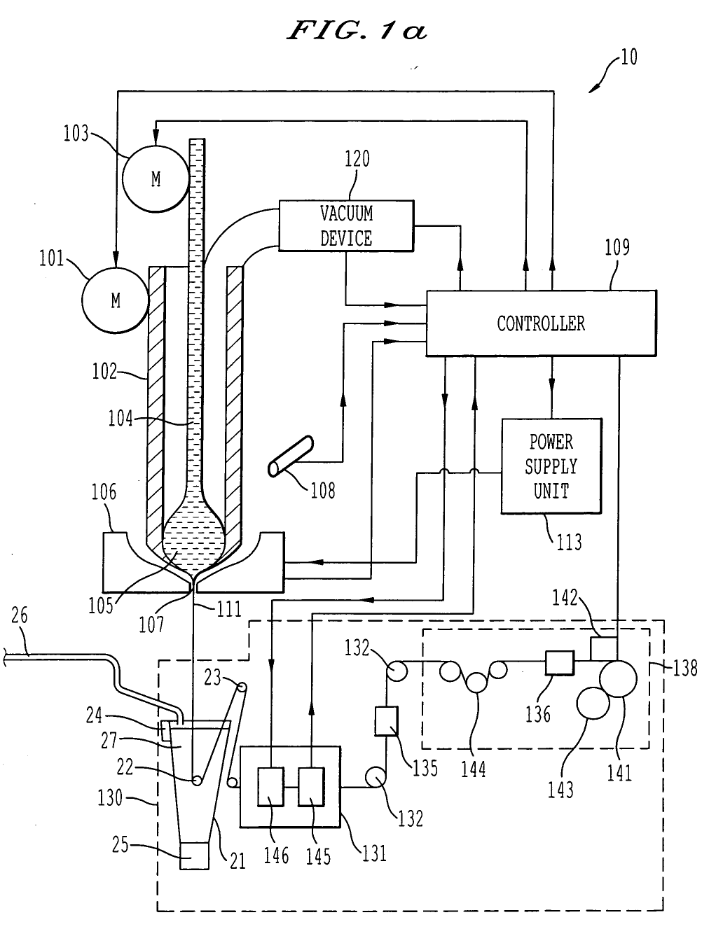

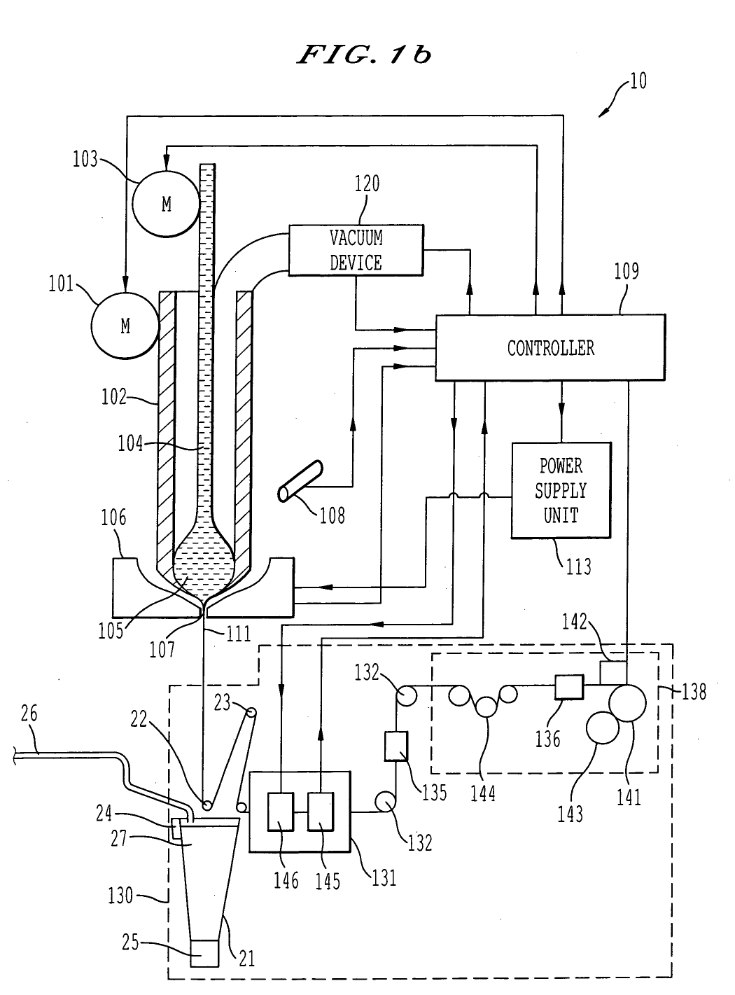

Referring now to the drawings, wherein like reference numerals designate identical or corresponding parts throughout the several views, FIGS. 1(a) and 1(b) show in overall detail a system for generating glass-coated microwire according to the present invention. The main focus of the present invention is the cooling system utilized in the system for generating glass-coated microwire, and the cooling system can be applied to different systems for generating glass-coated microwire than as shown specifically in FIGS. 1(a) and 1(b).

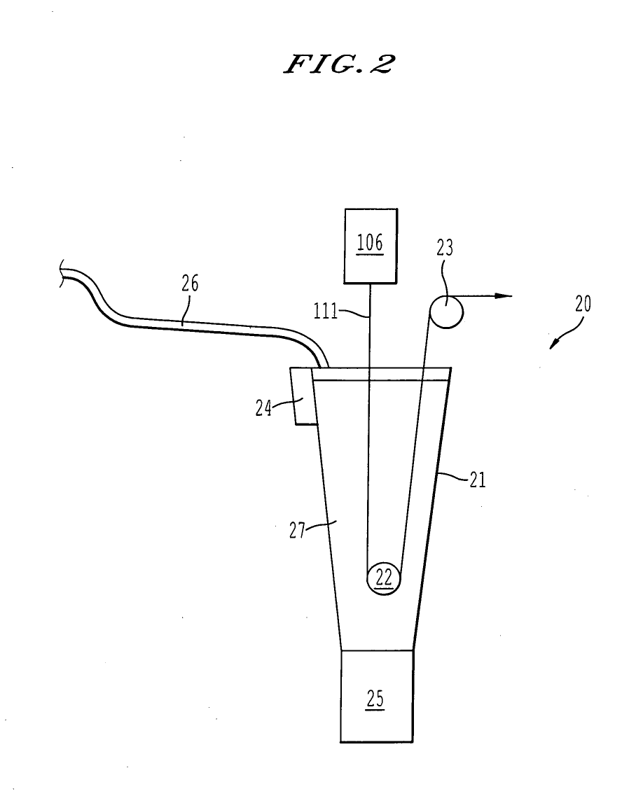

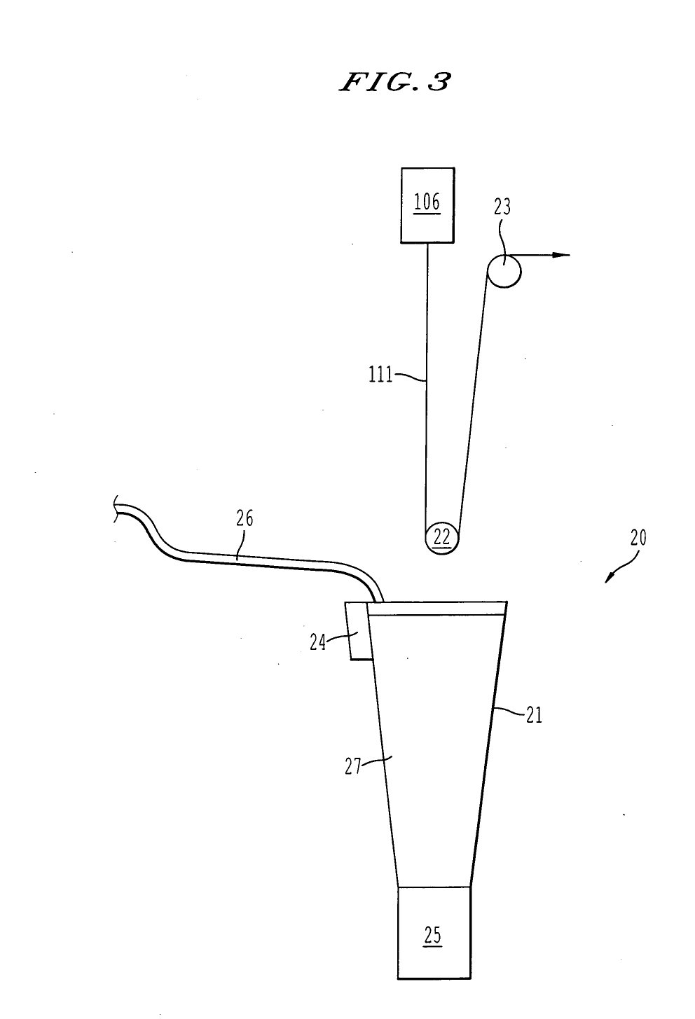

FIGS. 1(a) and 1(b) specifically show details of a cooling system 20 utilizing the present invention to cool a glass tube filled with molten metal 111 output from a drop 105 after passing through a furnace 106. FIG. 1(a) shows the cooling system in an operational position and FIG. 1(b) shows the cooling system in a retracted position. FIGS. 2 and 3 show details of the cooling system, FIG. 2 showing the cooling system in the operational position and FIG. 3 showing the cooling system in the retracted position.

Referring to FIG. 1, a system for a mass manufacture of continuous lengths of glass coated microwire is shown in schematic form in order to illustrate the system and process according to one embodiment of the present invention. It should be noted that the blocks in FIG. 1 are intended as functional entities only, such that the functional relationships between the entities are shown, rather than any physical connections and/or physical relationships. The system of FIG. 1, generally identified by reference numeral 10, includes a suitable glass feeder mechanism diagrammatically represented by a circle 101 for providing a supply of a glass tubing 102. The system also includes a rod feeder mechanism diagrammatically represented by a circle 103 for providing a supply of a rod, bar or wire 104 made of a core material. It should be appreciated that the mechanisms 101 and 103 can be both configured in one feeder device that may serve a multiple function for providing a supply of glass and core materials. The glass feeder mechanism 101 is controllable by a glass feeder signal and includes a driving motor (not shown) which acts on the glass tubing 102 for providing a supply of a glass material with a required speed. By the same token, the rod feeder mechanism 103 is controllable by a rod feeder signal and includes a driving motor (not shown) which acts on the rod 104 for providing a supply of a core material with a required speed. The glass and rod feeder signals are generated by a controller 109 configured to control the system 10.

Examples of the glasses of the glass tubing 102 include, but are not limited to, glasses with a large amount of oxides of alkali metals, borosilicate glasses, aluminosilicate glasses, etc. It should be understood that various alternative glasses may be selected by one skilled in the art for the particular desired application and environment in which the coated wire composite is to be used. Pyrex glass, Soda glass and Quartz glass are the most common.

A tip of the glass tubing 102 loaded with the rod 104 is introduced into a furnace 106 adapted for softening the glass material making up the tubing 102 and melting the rod 104 in the vicinity of the exit orifice 107, such that a drop 105 of the wire material in the molten state is formed.

According to one embodiment of the invention, the furnace 106 includes at least one high frequency induction coil, e.g. one wind coil. The operation of the furnace 106 is known per se, and will not be expounded in details below.

An exemplary furnace that has been shown to be suitable for the manufacturing process of the present invention is the Model HFP 12, manufactured by EFD Induction Gmbh, Germany.

The temperature of the drop 105 is measured by a temperature sensor 108 pointing at the hottest point of the drop. An example of the temperature sensor includes, but is not limited to, the Model Omega OS1553-A produced by Omega Engineering Ltd.

The temperature sensor 108 is operable for producing a temperature sensor signal. The temperature sensor 108 is coupled to the controller 109 which is, inter alia, responsive to the temperature sensor signal and capable of providing a control by, e.g., a PID loop for regulating the temperature of the drop 105 for stabilizing and maintaining it at a required magnitude. For example, the temperature of the drop can be maintained in the range of 800° C. to 1500° C.

It should be appreciated that one way of regulating the drop temperature is the regulation of the temperature of the furnace 106 by changing the furnace's power consumption. For this purpose, controller 109 is capable of generating a furnace power signal, by, e.g., a PID control loop, to a power supply unit 113 of the furnace 106. For example, when the consumption power increases, the drop temperature should also increase, provided by the condition that the position of the drop 105 does not change with respect to the furnace 106. However, since the furnace includes a high frequency induction coil, the increase of the consumption power leads to the elevation of the drop, due to the levitation effect. Hence, the temperature of the drop depends on many parameters and does not always change in the desired direction when only the consumption power is regulated.

An example of the power supply unit 113 includes, but is not limited to the Mitsubishi AC inverter, Model FR-A540-11k-EC, Mitsubishi, Japan.

According to one embodiment of the present invention, the compensation of the levitation effect is accomplished by the regulation of the gas pressure in the tubing 102. Thus, in order to avoid the droplet elevation due to the increase of the consumption power, the negative gas pressure (with respect to the atmospheric pressure) is decreased to a required value calculated by the controller 109.

For this purpose, the system 10 is further provided with a vacuum device identified by reference numeral 120 for evacuating gas from the tubing 102. The vacuum device 120 is coupled to the tubing 102 via a suitable sealable coupling element (not shown) so as to apply negative gas pressure to the inside volume of the tube 102 while allowing passage of the rod 104 therethrough.

The vacuum device 120 is controllable by a vacuum device signal generated by the controller 109 for providing variable negative pressure to the molten metal drop in the region of contact with the glass. The pressure variation permits the manipulation and control of the molten metal in the interface with the glass in a manner as may be suitable to provide a desirable result.

The system 10 is further provided with a receiver section 130 including a cooling device 20, arranged downstream of the furnace 106 and adapted for receiving and cooling a microwire filament 111 drawn out from the drop 105. Features of the cooling device 20 are detailed below. The microwire filament 111 can be drawn at a speed in the range of 5 m/min to 1500 m/min through the cooling device 20. The cooling device 20 is built in such a way that the filament 111 being formed passes though a cooling liquid where it supercools and solidifies, and thereafter proceeds as a microwire 112 to the other elements in a receiver section 130 arranged downstream of the cooling device 20.

The receiver section 130 also includes a spooler 138 for collecting the finished microwire product. The spooler 138 includes at least one receiving spool 141, a spool diameter sensor 142, a drive motor assembly 143, and a guide pulley assembly 144. The spool diameter sensor 142 is configured to measure an effective core diameter of the spool and to generate a spool diameter sensor signal representative of the value of the spool diameter.

The drive motor assembly 143 is controllable by a spool speed signal generated by the controller 109 for rotating the spool with a required cyclic speed in response to the spool diameter sensor signal. The cyclic speed is regulated to maintain the linear speed of the microwire at the desired value.

The receiver section 130 can further include a tension unit 131 having a tension sensor 145 configured to generate a tension sensor signal.

The tension unit 131 also includes a tension generator 146 controllable by a wire tension signal produced by the controller 109 in response to the tension sensor signal. The tension generator 146 is arranged to create tension of the microwire.

The receiver section 130 can also include a wax applicator 136 for waxing the microwire. The system 10 can also include a micrometer 135 arranged downstream of the tension unit 131 and configured to measure the microwire overall diameter, length, and other parameters, e.g., a microwire speed. The micrometer 135 is configured to produce, inter alia, a wire diameter sensor signal representative of the microwire overall diameter. The micrometer 135 is operatively coupled to the controller 109 that is responsive to the diameter sensor signal and is operable to generate a corresponding signal for regulating, inter alia, the drop temperature, to stabilize the overall microwire diameter.

The receiver section 130 also includes a required number of guide pulleys 132 arranged to provide a required direction to the microwire.

As discussed above, the glass tube filled with molten metal output from the drop 105 and passing through the furnace 106 is provided to a receiver section 130 including the cooling device 20. The glass tube with molten metal output from furnace 106 is initially provided to the cooling device 20. As shown in further detail in FIG. 2 showing the cooling device 20 in an operational state, the cooling device 20 includes a tank 21 into which the glass tube filled with molten metal 111 output from 110 is provided. The tank is filled with a cooling liquid 27. A pulley 22 is provided inside the tank and a pulley 23 is provided outside the tank, the glass tube filled with molten metal 111 passing over the pulley 22 and the pulley 23. A height control mechanism 25 is provided to precisely control the height of the tank 21. A liquid level sensor 24 is provided to control the liquid level within the tank 21. A liquid input device 26 is provided to input liquid into the tank 21 based on a control from the liquid level sensor 24.

To obtain the proper amorphous microstructure a rate of cooling of the glass tube filled with molten metal 111 input into the tank 21 must be controlled. Specifically, the amorphous or microcrystalline structure in the finally produced glass-coated microwire can be controlled by controlling the cooling rate, the nature of the cooling liquid, a distance from the exit orifice 107 to the liquid 27, etc.

Specifically, controlling the specific type of cooling liquid can influence a cooling rate, which can thereby influence the amorphous or microcrystalline structure in the finely produced glass-coated microwire.

Further, controlling the distance from the exit orifice 107 to the liquid 27 within the tank 21 can also be important. The distance between the exit orifice 107 and the liquid 27 within the tank 21 will influence the diameter of the molten metal 111 entering the cooling liquid 27. The closer the liquid 27 within the tank 21 is to the exit orifice 107, the bigger the diameter of the molten metal 111 entering the liquid 27. Thus, controlling the distance between the exit orifice 107 to the liquid 27 within the tank 21 can influence the diameter of the molten metal 111 entering the liquid 27, which thereby also influences the cooling rate of the molten metal 111. In that respect, the liquid level sensor 24 and cooling liquid input 26 can operate to precisely control the liquid level to be maintained at a desired height level within the tank 21, and to thereby maintain the distance between the exit orifice 107 and the height of the liquid 27 within the tank 21. Maintaining a stable liquid level results in being able to maintain a consistent wire diameter input into the liquid 27, and resultingly to realize a consistent diameter in a final output wire.

Typically, as noted above, it is desired to maintain a constant level of cooling liquid 27 within the tank 21, and therefore when the liquid level sensor 24 detects any decrease in the cooling liquid 27 level within the tank 21, a control will be issued to input more cooling liquid into the tank 21 through the cooling liquid input 26. Cooling liquid will be evaporating because of the input of the glass tube filled with molten metal 111 within the tank 21, and therefore liquid will always have to be resupplied to the tank 21 by the cooling liquid input 26.

FIG. 3 shows the cooling device 20 in a retracted state for any maintenance, for start up, setup, or for any other reason.

With the above-noted structure of the cooling device 20 in the present invention, the glass tube filled with molten metal 111 is inserted into a stable and non-turbulent cooling liquid 27, rather than passing through an unstable and turbulent stream. As a result, in the present invention a uniform cooling can be applied to all sides of the glass tube filled with molten metal 111 input into the tank 21, and a uniform and undistorted glass coating can be realized in a glass-coated microwire. Thus, a glass-coated microwire can be realized that has a very stable diameter, by being able to effectively and uniformly cool the wire very near a production point.

The cooling liquid 27 can take the form of any of water, an oil, alcohol, water with an oil emulsion in it, etc. as desired. Changing the cooling liquid can also change the amorphous and microcrystalline microstructures within the glass-coated microwire as desired.

Obviously, numerous modifications and variations of the present invention are possible in light of the above teachings. It is therefore to be understood that within the scope of the appended claims, the present invention may be practiced otherwise and as specifically described herein.

1. A system for generating glass-coated microwire, comprising:
(a) a unit outputting a glass tube filled with molten metal;
(b) a cooling device configured to receive the glass tube filled with molten metal, the cooling device including:
(b1) a tank filled with a liquid; and
(b2) at least one pulley provided in the tank around which the glass tube filled with molten material passes.

2. A system according to claim 1, further comprising:
(c) a liquid level sensor; and
(d) a liquid input configured to input the liquid into the tank to maintain a desired liquid level, based on an indication from the liquid level sensor.

3. A system according to claim 1, further comprising:
(c) a height control unit configured to control a height of the tank.

4. A system according to claim 2, further comprising:
(e) a height control unit configured to control a height of the tank.

5. A system according to claim 1, wherein the liquid is selected from the group consisting of: water; an alcohol; an oil; water having an oil emulsion.

6. A system according to claim 2, wherein the liquid is selected from the group consisting of: water; an alcohol; an oil; water having an oil emulsion.

7. A system according to claim 3, wherein the liquid is selected from the group consisting of: water; an alcohol; an oil; water having an oil emulsion.

8. A system according to claim 4, wherein the liquid is selected from the group consisting of: water; an alcohol; an oil; water having an oil emulsion.

9. A system for generating glass-coated microwire, comprising:
(a) a unit outputting a glass tube filled with molten metal;
(b) means for cooling the glass tube filled with molten metal, the means for cooling including:
(b1) means for containing a liquid; and
(b2) means for passing the glass tube filled with molten material through the means for containing.

10. A system according to claim 9, further comprising:
(c) means for sensing a liquid level; and
(d) means for inputting the liquid into the means for containing to maintain a desired liquid level, based on an indication from the means for sensing.

11. A system according to claim 9, further comprising:
(c) means for controlling a height of the means for containing.

12. A system according to claim 10, further comprising:
(e) means for controlling a height of the means for containing.

13. A system according to claim 9, wherein the liquid is selected from the group consisting of: water; an alcohol; an oil; water having an oil emulsion.

14. A system according to claim 10, wherein the liquid is selected from the group consisting of: water; an alcohol; an oil; water having an oil emulsion.

15. A system according to claim 11, wherein the liquid is selected from the group consisting of: water; an alcohol; an oil; water having an oil emulsion.

16. A system according to claim 12, wherein the liquid is selected from the group consisting of: water; an alcohol; an oil; water having an oil emulsion.
